(19) United States
(12) Patent Application Publication
(10) Pub. No.: US 2007/0115203 A1
(43) Pub. Date: May 24, 2007

(54) Method and arrangement for fitting an improved display device interface between a display device and a processor

(76) Inventor: Kauko O. Laakkonen, Polvitie (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 10/560,408

(22) PCT Filed: Jun. 14, 2004
(86) PCT No.: PCT/FI04/50092

§ 371 Date: Dec. 12, 2005

(30) Foreign Application Priority Data
Jun. 13, 2003 (FI) 20035096

(51) Int. Cl. G09G 5/00

(52) U.S. Cl. 345/3.1

(57) ABSTRACT

The invention relates to the connecting of an improved, intelligent display device interface to a processor that controls the display device through the display device interface. The arrangement according to the invention comprises a display device, an intelligent connection interface of the display device and a processor controlling the display device. In addition, the arrangement comprises a memory bus connected to the processor in order to realize the signaling between the processor and the display device connection interface, and an adapter circuit for matching the signals between the memory bus and the display device connection interface.

The invention relates to the matching of an improved, intelligent display device interface and a processor that controls the display device through a display device interface.

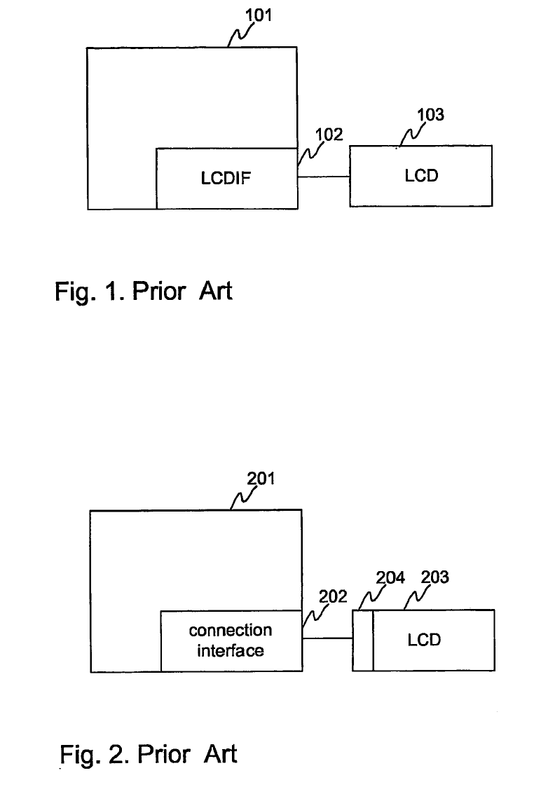

The display device functions are controlled according to the commands of the processor through an interface. A typical prior art solution is illustrated in FIG. 1, where there is shown a display device 103, a processor 101 and a connection interface 102 provided therebetween. A commonly used display device is an LCD 103 (liquid crystal display). The processor 101 controls all components of the device, also the functions of the display device under observation. In order to control the functions of the display 103, there is needed a connection interface 102, a circuit that directs the commands of the processor suitably to the display 103. By means of the connection interface 102 (LCDIF, liquid crystal display interface) there is reset the driver of the external display device 103, converted the commands obtained from the processor 101 in a form required by the display device 103, created the required protocols for the display device 103 and performed continuous updating. Typically known display connection interface, such as the above mentioned liquid crystal display connection interfaces, have a limited number of features that can be realized by means of the protocols defined by the connection interface. Generally it is required that the central unit has a separate display driver.

The quality of the equipment keeps improving, and at the same time more and more features are integrated therein. As a consequence, higher requirements are also set for the display device, which for the user is the most essential and most important interface. One example of an advanced connection interface 202, 204 is illustrated in FIG. 2. Also this improved connection interface 202, 204 of the drawing serves as a bus for electric signals from the processor 201 to the display device 203, which typically is the above mentioned liquid crystal display (LCD). The connection interface 202 includes protocols, according to which the display device 203 is controlled by means of the connection interface 204 connected thereto. By means of intelligent connection interfaces, there can be defined a given refresh rate, by which the display or only a part thereof is updated, so that it is not necessary to continuously scan the display, as was the case before.

Continuous updating is unnecessary and uses up resources that could be utilized for instance for data transmission or processing. When continuous updating is not necessary, power consumption drops essentially lower than when using the traditional connection interface.

Intelligent, progressive connection interfaces are used for realizing communication between a processor and a display device. In general, in these arrangements the bus employed between the processor and the display device is always a particular circuit designed for a given application, which serves as the physical connection interface. Typically inside the circuit there is constructed a permanently installed physical connection interface for each customer. This kind of special structure circuit is always remarkably more expensive than the generally available commercial processors. In addition, when there is required an integrated, stationary, physical interface individually for each customer, the use of an intelligent connection interface of the display is only restricted to these certain, specific processors, in which the physical connection interface is integrated already at the manufacturing step.

The objective of the invention is the matching of a display device and the controlling processors, so that the communication therebetween is realized in a simple fashion through an intelligent connection interface.

The objective is achieved so that the bus between the display device and the processor is formed through a memory bus by arranging the intelligent connection interface in the memory bus.

The invention is characterized by what is set forth in the characterizing parts of the independent claims. Embodiments of the invention are described in the dependent claims.

According to an embodiment of the invention, the intelligent connection interface is connected as part of the display device. According to an embodiment of the invention, the display device provided with an intelligent connection interface is connected via a generally used, existing memory bus to the processor controlling the display device. Apart from a normal memory bus between the memory unit and the processor, the memory bus also serves as a bus between the processor and the intelligent connection interface of the display. A display device according to an embodiment of the invention, provided with an intelligent connection interface, can be connected through a generally used memory bus to any available processor in a simple and reliable manner.

According to an embodiment of the invention, in between the memory bus and the intelligent connection interface, there is brought an adapter circuit that matches the signals between the memory bus and the connection interface, so that they function, particularly with respect to timing, in a way required by the buses and the segments located at the bus ends. Two segments, which in this case are the display device and the processor, can be connected together by means of so called glue logics, which is applied for making the segments to form a functional unit. The adapter circuit according to the invention can be realized in many different ways. Typically an adapter circuit is a simple circuit that synchronizes the signals and then transmits them in the correct order and at a correct time to the receiving segment. The signals sent from the adapter circuit are protected against interference in order to prevent electric interference before the signals meet the connection interface of the display device.

In applications where high frequency ranges are required, such as in telecommunications applications or in high speed network applications, the physical layer connections according to the invention often represent the weakest link. These connections must function smoothly in the vicinity of for instance 900 MHz GSM pulses (GSM, Global System for Mobile communication). In the intelligent display connection interface according to the invention, there are command series and protocols readily installed, and it can be applied in many different targets by means of a simple adapter circuit according to an embodiment of the invention. Thus the versatility, low power consumption and other features of the intelligent interface can be utilized, as matched with several different display controlling processors. Moreover, when the circuit structure and bus can be generally applied in various types of processors, they can be made remarkably more cost effective than in a case where they are produced as a specific circuit individually for each application.

The invention is described in more detail below with reference to the appended drawings, where

FIG. 1 illustrates an arrangement according to the prior art,

FIG. 2 illustrates another arrangement according to the prior art,

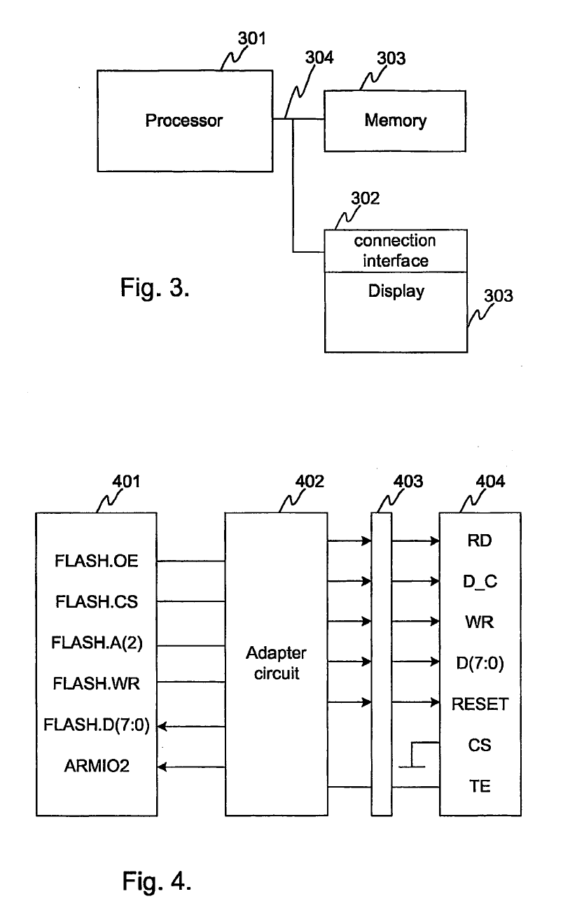

FIG. 3 illustrates an arrangement according to an embodiment of the invention,

FIG. 4 illustrates an arrangement according to an embodiment of the invention,

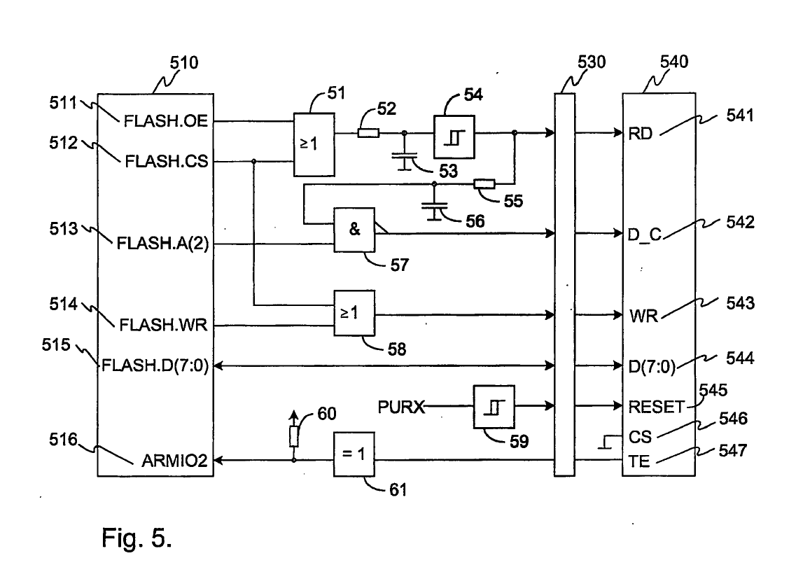

FIG. 5 illustrates an arrangement according to an embodiment of the invention, and

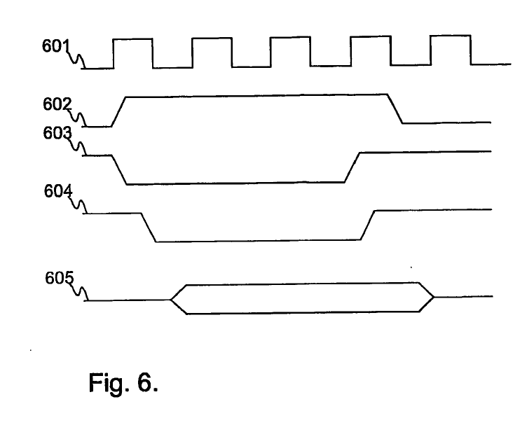

FIG. 6 illustrates an arrangement according to an embodiment of the invention.

FIGS. 1 and 2 were explained in more detail in previous, in the section describing the prior art. Let us now observe some embodiments of the invention in more detail with reference to FIGS. 3-6. The embodiments illustrated in the drawings are exemplary and do not restrict the scope of the invention to the described detailed arrangements only.

FIG. 3 is a block diagram illustrating how a functional connecting bus according to an embodiment of the invention is created between a processor 301 and a display device 303. According to the invention, in the display device 303 there is integrated an intelligent connection interface 302, which is connected to the processor controlling the display device, so that the signaling between the processor 301 and the display device connection interface 302 is realized through a memory bus 304 connected to the processor 301. Signals between the memory bus 304 and the display device connection interface 302 are made compatible by means of an adapter circuit according to the invention.

The arrangement comprises a display device 303, an intelligent connection interface 302 of the display device, and a processor 301 controlling the display device. From the processor 301, there is arranged a memory bus 304 to the memory unit 303 which contains for instance non-volatile flash memory. According to an embodiment of the invention, the memory bus 304 connected to the processor 301 also serves as a bus in order to realize signaling between the processor 301 and the display device connection interface 302. According to the invention, the arrangement also includes an adapter circuit (not illustrated in FIG. 3) in order to match the signals between the memory bus 304 and the display device connection interface 302. The processor 301 and the display device 303 constitute the functional segments that are according to an embodiment of the invention connected via the memory bus 304 by means of a simple adapter circuit.

A connection interface 302 according to the embodiment can be for example the intelligent MeSSI (Medium Speed Screen Interface) connection interface developed by Nokia Oyj (Keilalahdentie, Helsinki, Finland), whereby display functions are made more effective and versatile. The MeSSI serves as a bus for electric signals from the processor to the display device, which is typically a liquid crystal display. In addition, the MeSSI includes protocols according to which the display device is controlled. By means of the MeSSI there can also be defined a certain refresh rate, by which the display or only a part of it is updated, in which case it is not necessary to continuously scan the display, as is the case when using simpler prior art display connection interfaces. There are more processor resources more effectively available for other functions, when a continuous updating of the display is not required. One of the most important advantages achieved by means of the MeSSI is the fact that power consumption is essentially decreased in comparison with the use of a traditional connection interface, because through the MeSSI, there can be defined a so called idle state, in which the display is in passive mode and consumes a minimum amount of power. When the display is not active, it is set in a passive idle mode, during which updating is not necessary, and the bus is free for other usage. The display power consumption can thus be reduced from the order of milliampers to the order of microampers. In that case there is no continuous traffic on the bus from the processor to the display device.

For realizing communication between the processor and the display device there can be used for instance said intelligent MeSSI connection interfaces or other intelligent connection interfaces that have similar improved properties. According to an embodiment of the invention, the processor and the display device are physically connected through an existing memory bus, and there is no need for a customer-specific connection interface. Thus the intelligent interfaces can be connected by means of a simple adapter circuit to various different commercial processors.

According to an embodiment of the invention, the signals obtained from the processor 301 can be directed to the display connection interface 302 so that the employed bus is the existing memory bus 304. In this case there is no need to establish any particular specific buses. In the display device 303, there is in this embodiment integrated an intelligent connection interface 302, for example a MeSSI. The processor 301 is via the memory bus 304 in connection with the memory unit 303, which is for instance non-volatile flash memory. According to an embodiment of the invention also data and control signals proceed along this two-way memory bus between the processor 301 and the display device 303. On the bus of the intelligent connection interface 302, there is no continuous traffic, but the communication takes place according to the demands of the situation. One memory bus 304 serves both as a normal memory bus and simultaneously as a bus from the processor 301 to the display connection interface 302. According to an embodiment of the invention, the employed bus between the processor and the display can be any general memory bus. A bus is the physical layer for transmitting signals between the display segment and the processor. All display functions are according to an embodiment of the invention carried out through the memory bus. Along the bus from the processor to the display, there proceed the commands used for controlling the display contents and operations. From the display to the processor, there proceeds information of the mode of the display. Between the processor and the display, there is transmitted data only when necessary, i.e. in a situation where changes have taken place either in the functions or on the display. According to an embodiment, the processor does not need a separate display driver. The logics of the connection interface 302 vary according to the processor 301 in question. The traffic between the processor and the display on the bus 304 is arranged so that data and control signals arrive in the receiving segment in the phase and order required by the receiving segment.

According to an embodiment of the invention, the data bus of the memory bus is connected to the data bus of the intelligent display driver circuit. The read and write signals of the display driver circuit are connected to the read and write lines of the memory bus. Respectively, other control signals of the display driver are connected to corresponding memory bus lines. According to an embodiment of the invention, in the memory bus there is connected a processor, a memory unit and a display driver circuit. If for example the processor wants to write on the display, the processor starts the write cycle by first setting address and control signals for the bus. By means of an individual address, the receiving segment detects that the signals on the bus are meant for it to be received. Of the addresses, there are formed chip select signals (CS, chip select), according to which the chip to be used is individually selected. According to an embodiment, the chip select logics are integrated in the processor. According to another embodiment of the invention, the chip select logics can be realized by means of separate components. When the processor then sends data to the display, the basic assumption is that the transmitted data to be written on the display reaches its destination and is received. The processor can check from the display status register that at least certain commands were successfully transmitted.

In FIG. 4, there is shown in more detail how the memory bus 401 is adapted in the connection interface 404 by means of an adapter circuit 402 according to an embodiment of the invention. On the memory bus 401, there are transmitted data signals and control signals. The signals on the memory bus 401, and more generally all commands to be transmitted to the connection interface 404 vary according to the processor in question. The basic assumption is that the processor knows what signals or commands can be transmitted to the display connection interface, and according to which protocol. By means of the protocol command base, it is for example possible to print text and graphics on the display, inquire and update display information and adjust the display contrast and background light. The details and logics of the adapter circuit 402 according to an embodiment of the invention are designed and realized according to the processor in question. In the embodiment of FIG. 4, the adapter circuit 402 is realized by means of a few gates, so that some signals are combined and/or slowed down. The adapter circuit 402 synchronizes the signals obtained from the memory bus and directed to the display connection interface 404, so that they are adapted in the order required by the connection interface 404 and further by the display device, and respectively the signals transmitted from the connection interface 404 to the processor are synchronized to be suitable for the memory bus and the processor.

In FIG. 4, on the memory bus 401 there is by way of example illustrated only a few signals to be directed from the memory bus to the display connection interface. FLASH.OE represents a signal for reading from the display, and FLASH.WR represents a signal for writing on the display. To these, there is in the adapter logics combined FLASH.CS, by which a certain display is set to be active during a read or write operation. The FLASH.A(2) signal defines whether the signaling in question represents data to be sent to the display, or control signaling. FLASH.D(7:0) is a two-way data bus, typically containing 8 data lines. The ARMIO2 signal can receive the information, on the basis of which the display writing is synchronized, so that there are not created two overlapping images (so called tiering effect).

When the signals are synchronized by the adapter circuit 402, and they are thus arranged in the order required by the display connection interface 404, the signals are generally also interference protected in order to prevent possible electric interference. In FIG. 4, the interference protection is realized in a known fashion in block 403. Then the adapted, interference protected signals are directed to the connection interface 404. Of the signals of the connection interface 404, there is here represented by way of example the read signal RD describing the read mode of the display, the write signal WR that indicates the write mode on the display, data signals D(7:0) which constitute an 8 line data bus corresponding to the memory bus data signals, and the reset signal RESET, through which the initial settings of the arrangement are taken care of. In FIG. 4, there also are illustrated the address signal D_C that indicates whether the signal is a data or a control signal, CS that defines whether the display is active or not, and TE that is connected to the synchronizing of the display writing.

The data signals D(7:0) proceed on a two-way bus. Consequently, data signals can be transmitted to be written on the display, or the data signals read from the display can be transmitted to the direction of the processor. Among one-way signal buses proceeding from the memory bus 401 towards the display connection interface 404, there are the write signal (WR), the signal indicating the activity of the display (CS), the address signal (D_C), the read signal (RD) and the arrangement reset signal (RESET). Only a one way output from the connection interface is located on the TE signal bus, on which there is transmitted the location of the read pointer to the host segment. The TE signal proceeds along a digital I/O (input/output) bus to the processor or to a DMA (direct memory access) controller.

According to an embodiment, only a required part of the display is updated. For instance, when a text should be written at a certain point of the display, the text location data and the text content are transmitted to the display. On the basis of these, the text content part is written on the desired location on the display, while the rest of the view remains the same. A typical frame structure of the commands transmitted by the processor contains the address of the target device, a read/write bit, the value of which defines the direction of the data transmission, a command identifier and data proper. In addition, the frame structure may also include a check sum by which the receiving segment can check the correctness and success of the transmission.

In FIG. 5, there is by way of example illustrated an adapter circuit in order to match the signals of an external memory bus 510 originated from a generally used processor with the MeSSI connection interface 540 of the display. The display read signal FLASH.OE 511 and the active chip select signal FLASH.CS 512 are fed into the OR gate 51. The OR gate 51 ensures that the RD signal of the display is only activated if FLASH.OE 511 and FLASH.CS 512 go down to zero (“0”). The resistor 52 and the condensator 53 form a delay circuit that synchronizes the RD timing to be suitable for the display. The output of the delay circuit is buffered by a gate 54. The output of the buffer 54 is also connected, via another delay circuit, to the input of the NAND circuit 57. In this embodiment, the other delay circuit comprises a resistor 55 and a condensator 56. By means of said coupling, the timings of the D_C line 542 are modified to be suitable for the display at the read cycle.

The WR signal 543 of the display is formed by an OR circuit 58, to the inputs whereof there are connected FLASH.CS 512 and FLASH.WR 514 signals. The WR signal 543 is only activated if FLASH.WR 514 and FLASH.CS 512 go down to zero (“0”). FLASH.A(2) 513 indicates whether the cycle in question is a command or a data write cycle. The data proper proceeds between the data bus FLASH.D(7:0) 515 of the memory bus and the data bus D(7:0) 544 of the MeSSI along an 8-line data bus. Between the adapter circuit and the display, the signals proceed through an interference protection segment 503.

The reset signal RESET 545 resetting the initial state is directed through a buffer 59 that gives the signal direction to the MeSSI 540. A so-called PURX signal is the reset signal of the arrangement for LCD display units. The purx signal comes from UEM (Universal Energy Management), and it serves as a resetting RESET signal also for UPP (Universal Phone Processor). UEM and UPP are both application specific circuits (ASIC, application specific integrated circuit).

The TE signal 547 is connected to a so-called tearing effect that is detected as a visual on the display, when the display panel obtains image data from two different routes and forms an image simultaneously according to both of said image data. This phenomenon is created when both the memory unit and the display device have access to the same display memory unit, and the write pointer of the memory unit and the read pointer of the display device are not suitably synchronized. In that case it may happen that the display is updated in different frames on the basis of the received image data. This phenomenon is avoided, when the display sends the location data of the read pointer to the host unit; in this embodiment the TE signal 545 is transmitted to the I/O bus (input/output) through the gate 61. The 1.8 volt logic layers of the display are adapted, by a 2.8 volt level adapter, to the volt levels required by the ARMIO2 signal 516 of the processor. In an embodiment where the processor and the display use same logic layers, the adaptation is not necessary. The receiving ARMIO2 signal 516 of the memory bus 510 can be configured by software that is capable of defining, on the basis of the received signal, for example an interruption, or transmitting a DMA (direct memory access) request. The use of the TE signal is not necessary, but it is utilized in the display interface.

FIG. 6 shows an example of synchronizing the read cycle in an adapter circuit according to an embodiment of the invention. The FLASH.OE signal 603 of the memory bus is slowed down, so that it corresponds to the timing requirements of the display device. Typically this is carried out by software. First there is set a maximum number for the wait modes of the read signals. Thereafter there is reset the lowest clock frequency FCLK (flash clock lowest) 601. The D_C signal 602 indicates that the signal in question is a data signal. The D_C signal 602 always rises up to status “1” before the read operation. The status of the RD read signal 604 is changed to correspond to the FLASH.OE signal 603 indicating the read operation. In FIG. 6 it is clearly seen how the cycle of the FLASH.OE signal 603 is repeated in the RD read signal 604. The read display data proceeds on the data bus D(7:0) 605. Generally, when realizing signal synchronization, it is necessary to take into account properties of the used components, such as for instance gate delays, reset times, mode change/shift durations and pulse widths.

An adapter circuit according to the embodiment can be installed on a circuit board as a continuation of the processor bus. The processor is capable of producing the commands to the connection interface of the display. The commands of the processor are directed along the memory bus, via the adapter circuit, in the right order, and synchronized to the connection interface of the display device. Before the arrival of the synchronized signals at the connection interface of the display device, they are protected against interference. The logics of the adapter circuit to be installed in the bus arriving to the connection interface varies according to the employed processor. The adapter circuit adapts the signals electrically and synchronizes them for the connection interface of the display. The employed bus is a non-synchronized memory bus. By means of an adapter circuit according to the invention, the signaling between the processor controlling the display device and the connection interface of the display device is carried out so that the signaling between the processor and the connection interface of the display device is realized through a memory bus connected to the processor, in which case the adapter circuit electrically matches the display device connection interface and the memory bus with each other. The adapter circuit is provided with gates for matching the synchronization of the signals between the display device connection interface and the memory bus and for physically connecting the connection interface and the memory bus to form a uniform bus.

The most generally used display device is a liquid crystal display. However, the type of the display device does not restrict the applicability of the invention, but the arrangement according to the invention can also be used in other types of displays, such as for instance self-illuminating displays (OLED, organic light emitting diode) which do not require the use of background light Also the connecting of respective intelligent connection interfaces in the display device and via the memory bus to the processor can be realized within the scope of the invention.

1. Arrangement including a display device (303) and a processor (301) controlling the display device, wherein the arrangement comprises:
an intelligent display device connection interface (302) integrated in the display device,
a memory bus (304) connected to the processor (301) in order to realize signaling between the processor (301) and the display device connection interface (302), and
an adapter circuit (402) in order to match signals between the memory bus (401,510) and the display device connection interface (404,540).

2. The arrangement according to claim 1, wherein the intelligent display device connection interface is MeSSI (Medium Speed Screen Interface) (302).

3. The arrangement according to claim 1, wherein the memory bus (304) connected to the processor (301) is a non-synchronized memory bus.

4. The arrangement according to claim 1, wherein the memory bus (304) is for realizing signaling between the processor (301) and a memory unit (303), as well as between the processor (301) and the display device connection interface (302).

5. The arrangement according to claim 1, wherein the adapter circuit (402) includes means for synchronizing the signals (511,512, 513,514, 515,516) of the memory bus (401,510) in an order required by the display device.

6. The arrangement according to claim 1, wherein the adapter circuit (402) is provided with gates (51,54, 57,58, 59,61) in order to match the signals (603,604) between the memory bus (401,510) and the connection interface (404,540).

7. The arrangement according to claim 1, wherein the arrangement also includes an interference protection segment (403,530) in order to prevent electric interference.

8. Method for connecting a display device (303) to a processor (301) controlling the display device, comprising:
integrating an intelligent connection interface (302) in the display device (303),
providing a memory bus (304) for providing signaling between the processor (301) and the display device connection interface (302) wherein the memory bus (304) is connected to the processor (301), and
providing an adapter circuit (402) for adapting signals between the memory bus (401,510) and the display device connection interface (404,540) wherein the signals are adapted to be compatible by said adapter circuit (402).

9. Method according to claim 8, wherein the memory bus (304) connected to the processor (301) is arranged to function both as a bus between the processor (301) and a memory unit (303), and a bus between the processor (301) and the display device (303).

10. Method according to claim 8, wherein the adapter circuit (402) is used for synchronizing signals (603,604) between the memory bus (401,510) and the display device connection interface (404,540) to be compatible.

11. Method according to claim 8, wherein the memory bus (401) and the display device connection interface (404) are connected by glue logics together in order to achieve communication therebetween.

12. Adapter circuit display device for realizing signaling between the controlling processor (301) and the display device (303), wherein the signaling between the processor (301) and the display device connection interface (302,404, 540) is realized through said memory bus (304,401, 510) connected to the processor (301), and that the adapter circuit (402) electrically matches the display device connection interface (404,540) and the memory bus (401,510).

13. Adapter circuit according to claim 12, wherein the adapter circuit (402) is provided with gates (51,54, 57,58, 59,61) for synchronizing the timing of the signals (603,604) between the display device connection interface (404,540) and the memory bus (401,510), and for combining the connection interface (404,540) and the memory bus (401,510) as a physical, uniform bus.

14. The arrangement of claim 5, wherein the adapter circuit (402) is provided with gates (51,54, 57,58, 59,61) in order to match the signals (603,604) between the memory bus (401,510) and the connection interface (404,540).
